(19) United States
(12) Patent Application Publication
(10) Pub. No.: US 2021/0026021 A1
(43) Pub. Date: Jan. 28, 2021

(54) RECEIVER FOR SATELLITE NAVIGATION

(71) Applicant: SEPTENTRIO N.V., Leuven (BE)

(72) Inventors: Daniel SALLAERTS, Aarschot (BE); Koen PAUWELS, Bierbeek (BE); Wim DE WILDE, Oud-Heverlee (BE)

(73) Assignee: SEPTENTRIO N.V., Leuven (BE)

(21) Appl. No.: 15/999,093

(22) PCT Filed: Feb. 10, 2017
(86) PCT No.: PCT/EP2017/053069

§ 371 Date: Aug. 17, 2018

(30) Foreign Application Priority Data
Feb. 17, 2016 (EP) 16156082.6

(51) Int. Cl. G01S 19/30; G01S 19/29; G01S 19/37

(52) U.S. Cl. CPC G01S 19/30; G01S 19/37; G01S 19/29

(57) ABSTRACT

A receiver for satellite navigation includes a signal processor for deriving from a satellite signal a pseudorandom sequence of code chips, a converter for producing a digitized version of the received PRN sequence, a first and second shift register (3, 7), a code generator (4), a set of correlators, circuitry for summing correlation values and circuitry for determining a maximum of the summed correlation, and a scheduler (20). The receiver includes at least one multiplexer (6, 24), configured to transform multiple PRN sequences into an interleaved sequence and to enter the interleaved sequence into the first or second shift register (3, 7). The summing circuitry has multiple summing circuits (11) for separately summing correlation values related to the multiple PRN sequences. The circuitry for determining a maximum is configured to determine the maximum in one or more subgroups of sums determined by the multiple summing circuits (11).

### FIELD OF THE INVENTION

The present invention is related to satellite navigation and in particular to the acquisition unit of a satellite navigation receiver.

### STATE OF THE ART

Global Navigation Satellite System (GNSS) is a general name for a satellite navigation system. A GNSS system comprises, among other things, a constellation of multiple navigation satellites, which are orbiting the earth and which each transmit dedicated navigation signals also called ‘ranging signals’. GNSS reception functionality enables a device to receive, acquire and track the ranging signals of multiple satellites. GNSS signal processing functionality further enables determining geographic positioning of any person, vessel or object equipped with a navigation receiver. All systems built so far work according to the same principle: the signal from at least four satellites is evaluated and the receiver computes its own position.

The operational systems which are best known are the American GPS system and its Russian counterpart, Glonass. The European Galileo and the Chinese Compass are more recent systems.

Each satellite transmits one or more carriers modulated with one or more pseudorandom (PRN) codes. The received signal consists of a Doppler-shifted and time-delayed version of that transmitted signal. Because each navigation satellite has a different velocity and is at a different distance from the receiver, the Doppler shift and the time delay is satellite-dependent.

In the first seconds of operation of a GNSS receiver, the Doppler frequency shifts and delays of the visible satellites are unknown and the main receiver activity is to search the Doppler/delay space for available signals. This phase is referred to as ‘initial acquisition’. At the end of this phase, the receiver knows (i) which satellites are visible, (ii) at which approximate Doppler frequency and (iii) at which approximate delay.

It is important that the initial acquisition of signals be performed as fast as possible, as it constitutes an important contribution in the so-called ‘time-to-first-fix’, i.e. the time from start-up of the receiver (e.g. after having been in a standby mode) until the first position is available to the user. Upon completion of the initial acquisition, the receiver switches into signal tracking mode, where the Doppler and delay parameters of the signals of each individual satellite are accurately tracked and measured. Signal tracking involves different algorithms than acquisition and must meet very different requirements. In acquisition the focus is set on the speed at which the search space is scanned, whereas in tracking the focus is set on the accuracy of the Doppler and delay estimation.

To enable efficient and fast acquisition of new signals such as Galileo, Glonass or modernized GPS, several techniques have been proposed, mostly relying on the presence of a large number of correlators, usually placed in a dedicated acquisition unit operating independently of the channels. These correlators compute the cross-correlation function between the received satellite signals and a local replica of the PRN code that the receiver is programmed to acquire. The position of the maximum of this cross-correlation function indicates the satellite signal delay.

The core of an acquisition unit of the latter type consists of a set of shift registers, a first shift register receiving sample values of an incoming PRN sequence, a second shift register receiving samples of a known PRN replica. The sampled replica is stored in a buffer memory and then the correlation is calculated between the buffer and progressively shifting versions of the incoming PRN sequence in the first shift register. For each correlation, the results are added up and the sum is stored. The maximum of the sums determines a match between the local replica and the incoming code.

A problem with these types of acquisition units is that they are often too slow. Determining which one of a given number of satellites generates an incoming PRN sequence and determining the Doppler shift may take considerable time, as several replicas and several Doppler shifts need to be verified sequentially.

### SUMMARY OF THE INVENTION

The invention is related to a receiver for satellite navigation as disclosed in the appended claims. The receiver of the invention is equipped with an acquisition unit based on the same principle as described above, i.e. comprising shift registers and correlators, but which is capable of processing several signals simultaneously, so that the acquisition phase may be performed faster than in prior art receivers.

The invention is firstly related to a receiver for satellite navigation comprising:
an antenna for capturing a satellite signal,
a signal processor for deriving from the satellite signal a pseudorandom sequence of code chips, at a chipping frequency f₀,
A converter for producing a digitized version of the received PRN sequence in the form of a sequence of samples at a sampling frequency fₛ,
a first shift register for receiving sampled values of the received PRN sequence,
a code generator for generating one or more replicas of respectively one or more pre-defined PRN codes, the replica or replicas having the form of a sequence of samples at the sampling frequency fₛ,
a second shift register for receiving sampled values of a PRN replica sequence,
a set of correlators for determining the correlation between the samples of the PRN replica sequence in the second shift register and the samples of the received PRN sequence in the first shift register,
circuitry for summing correlation values and circuitry for determining a maximum of the summed correlation values to thereby determine a match between the received PRN sequence and a PRN replica,
a scheduler for controlling at least the operation of the code generator, the shift registers, the correlators the summing circuitry and the circuitry for determining a maximum,
   characterized in that:
the receiver comprises at least one multiplexer, configured to transform multiple PRN sequences into an interleaved sequence and to enter said interleaved sequence into the first or second shift register,
the summing circuitry comprises multiple summing circuits for separately summing correlation values related to the multiple PRN sequences,
the circuitry for determining a maximum is configured to determine the maximum in one or more subgroups of sums determined by the multiple summing circuits.

According to an embodiment, the receiver comprises a multiplexer configured to transform multiple different PRN replica sequences or multiple copies of the same PRN replica sequence into an interleaved sequence, and to enter said interleaved sequence into the second shift register.

The receiver of the invention may further comprise:
circuitry for duplicating the received PRN sequence on a plurality of parallel lines,
a multiplier and a numerically controlled oscillator provided in relation to each of a plurality of said parallel lines, for applying a different frequency shift to a plurality of duplicates of the received PRN sequence,
a multiplexer configured to transform said plurality of frequency-shifted duplicates into an interleaved sequence and to enter said interleaved sequence into the first shift register.

According to an embodiment, the sampling frequency fₛ is higher than the chipping frequency f₀.

The scheduler may be configured to control the operation of the multiplexer or multiplexers, in such a way that the scheduler is capable of the number of input channels of the multiplexer that are activated.

According to an embodiment, the received PRN codes and the PRN replica codes comprise 1023 chips per millisecond.

According to an embodiment, the received PRN codes and the PRN replica codes comprise 4092 chips per 4 milliseconds, and wherein the 4092 chips are divided in 4 groups of 1023 chips, and wherein the four groups of a code replica are transformed into an interleaved sequence.

According to an embodiment, the at least one multiplexer is an 8-1 multiplexer.

The invention is equally related to the use of a receiver according to the invention for acquiring PRN signals comprising 1023 chips per millisecond.

The invention is equally related to the use of a receiver according to the invention for acquiring PRN signals comprising 4092 chips per 4 milliseconds, and wherein the PRN replicas of these signals are divided into four blocks of 1023 chips, and wherein the four blocks are transformed into an interleaved sequence.

### BRIEF DESCRIPTION OF THE FIGURES

FIG. 1 illustrates the components of an acquisition unit of a receiver according to a first embodiment of the invention.

FIG. 2 illustrates the interleaved filling of the second shift register in the embodiment of FIG. 1.

FIG. 3 illustrates a second embodiment of the invention.

FIG. 4 illustrates the interleaved filling of the second shift register in an embodiment wherein two Galileo-type codes are verified simultaneously.

FIG. 5 illustrates the interleaved filling of the first shift register in an embodiment wherein two Doppler-shifted Galileo E1B or E1C codes are processed simultaneously.

FIG. 6 illustrates the interleaved filling of the second shift register in the same embodiment illustrated by FIG. 5.

### DETAILED DESCRIPTION OF THE INVENTION

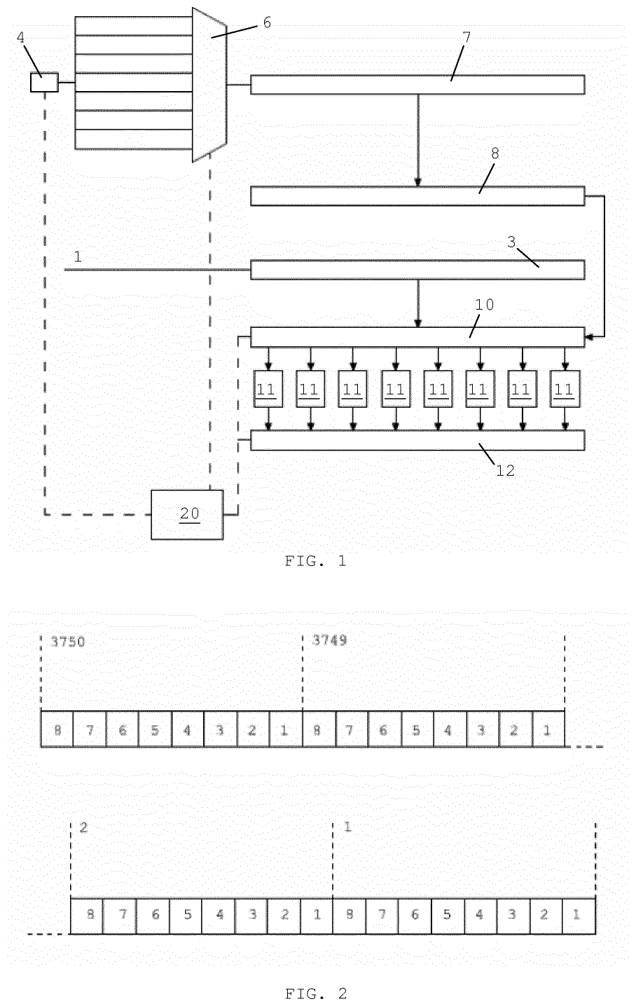

By adding one or more multiplexers to the above-described acquisition unit design, the receiver of the invention makes it possible to compare a received signal to multiple code replicas simultaneously, or to compare multiple Doppler-shifted versions of the same signal to one single code replica. The architecture of the acquisition unit according to a first embodiment of the invention is illustrated in FIG. 1. The numerical values cited hereafter are used by way of example only and they do not limit the scope of the invention. A satellite signal is received by an antenna (not shown) and processed by a signal processor (not shown) in order to derive an incoming PRN sequence on line 1. The signal processor required to obtain the PRN sequence is known in the art and not described here in detail. The incoming PRN sequence is a sequence of code chips (0 and 1 or equivalent), at a chipping rate of 1.023 MHz (1023 chips per millisecond), transmitted from a satellite that is within range of the receiver. The receiver however doesn't know yet which satellite is transmitting the signal, and must compare several code replicas to the received signal in order to find a match and subsequently track the satellite signal. The incoming signal 1 is a digitized signal, i.e. the analog signal received from the satellite has been treated by one or more A/D converters and possibly conditioned by other analog or digital signal processing tools known to the skilled person, leading to a representation of the incoming PRN signal as a sequence of digital samples at a given sample frequency. In the presently described embodiment, the sample frequency fₛ is 30 MHz. The sample frequency is preferably higher than the chipping rate. The sampled values are entered at a given clocking rate into a first shift register 3.

The shift register 3 has 30000 registers. During or prior to the acquisition of the satellite signal, different code replicas stored in the memory of the acquisition unit are generated by a code generator 4 and sampled at the same sampling frequency fₛ, after which the 8 sampled signals are fed in parallel to an 8-1 multiplexer 6. Preferably the sampling and multiplexing of the pre-stored code replicas takes place completely in the digital domain, as the codes are stored in the form of digital sequences in the memory of the receiver. Such digital (re)sampling and multiplexing is known by the skilled reader and therefore not described here in detail. The meaning of the term ‘multiplexer’ in the context of this application includes any circuit that establishes the multiplexing function as described hereafter. The output of the multiplexer 6 is fed into a second shift register 7, equally having 30000 registers. The multiplexer thus produces an interleaved stream of samples of the 8 code replicas. When the 30000 registers of the second shift register 7 are filled, they contain 8 times 3750 samples of each code replica, in the manner illustrated in FIG. 2. Each group of 8 registers comprises one sample for each of the 8 different PRN codes. The first group of 8 registers (having been filled last) comprises sample no 3750 of the 8th to the 1st code respectively; the last group of 8 registers (having been filled first) comprises sample no 1 of the 8th to first code respectively. These 300000 registers are then copied to a buffer 8, and kept there during the rest of the calculation, described hereafter.

The correlation is calculated between the 30000 samples in the buffer 8 and the 30000 samples of the received PRN sequence in the first shift register 3. This is done by a set 10 of 30000 correlators, which are basically XOR circuits, yielding a 1 for matching samples (both 0 or both 1) and a 0 for non-matching samples (0 and 1 or vice versa). After that, there are 8 separate summing circuits 11 connected to the correlators, in a manner to calculate the sum of the correlation values determined for each of the 8 interleaved codes. These sums are stored in a memory 12 having 30000 memory areas. Every clock cycle, this process is repeated with the incoming signal shifted one register in the first shift register 3. So at the end of 30000 clock cycles, the memory 12 is filled with 8 times 3750 correlation sums, and the peak detection is done in every group of 3750 sums, to thereby detect a maximum. The group where a maximum is found indicates a candidate for the correct code. Preferably, the same computation is done several times and the sums or the squares of the sums are accumulated and averaged in the memory 12, before determining the maximum.

A hardware component 20 is referred to as a scheduler and described here by its function only: the scheduler 20 controls the succession of operations described above, as well as the operation of the multiplexer 6 and the memory access. It takes care of resetting, code generation, frequency shifting (see second embodiment) and accumulating periods. Additionally, it signals the end of the computation to an external processor through an interrupt mechanism. The manner in which the scheduler 20 can be brought into practice is not different from presently known receivers and therefore not described here in detail.

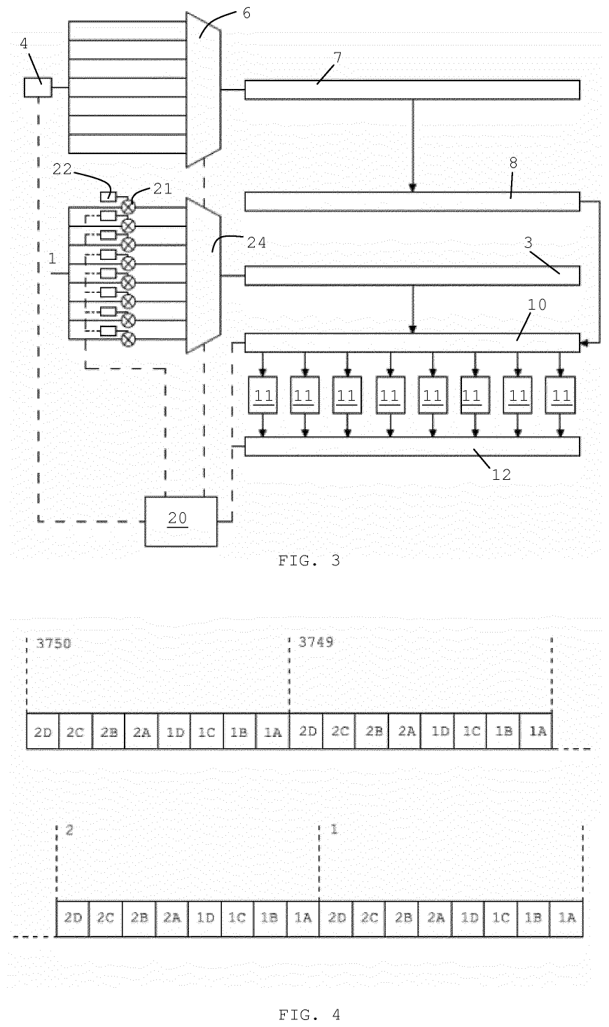

A second embodiment is shown in FIG. 3. The incoming PRN sequence on line 1 is coming from a known satellite, i.e. the receiver knows already which pre-defined PRN code, consisting of 1023 chips per millisecond, is received. The Doppler shift is however yet to be determined. To this aim, the incoming signal is split into 8 parallel lines and multiplied 8 times in 8 multipliers 21 with a signal produced by one of 8 numerically controlled oscillators 22. This NCO is a known circuit which multiplies the baseband signal with a locally generated sine and/or cosine pattern of a given frequency shift. Each of the 8 NCOs thus applies a different Doppler correction to the incoming signal. In this manner, 8 versions of the incoming signal are produced in parallel, each with a different Doppler shift. These 8 versions are sampled at a sampling frequency fs of 30 MHz, and fed into an 8-1 multiplexer 24. In the same manner as described above, an interleaved stream of the 8 PRN sequences is produced by the multiplexer 24 and fed into the first shift register 3.

The known code replica is produced 8 times by the code generator 4, each version is sampled at 30 MHz and fed to the 8-1 multiplexer 6, which feeds an interleaved stream of 8 times the same PRN code (namely the code of the known satellite transmitting the PRN sequence) into the second shift register 7. This interleaved stream is stored in the buffer memory 8 and the correlation is calculated in correlators 10 between the buffer and the 8 interleaved differential Doppler-shifted signals in the first shift register 3. In the same way as described above for the first embodiment, the correlation values are summed 8 times in separate summing circuits 11 and these sums are stored in memory 12. Detection of the maximum in the same manner as in the first embodiment reveals candidates for the correct Doppler shift. The scheduler performs the above-described function, and also the function of controlling the second multiplexer 24.

The architecture of FIG. 1 can also be used to verify two Galileo PRN codes of the type E1B or E1C. These Galileo codes consist of 4092 chips at a chipping rate of 1.023 MHz. The code may thus be divided into 4 different blocks A through D of 1023 chips. In a receiver of the invention, the second shift register 7 may be filled with two of these codes in an interleaved way, in the manner illustrated in FIG. 4. In the figure, ‘1A’ means ‘a sample of block A of the first code’, while ‘2A’ means ‘a sample of block A of the second code’. The correlation with the incoming signal, the summing and the maximum detection takes place in the same way as explained above in relation to FIG. 1.

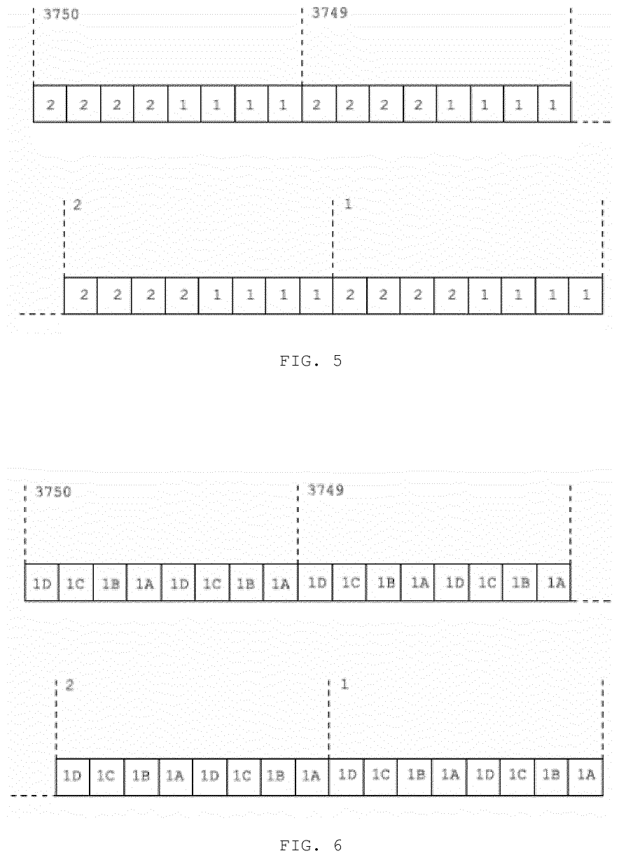

Likewise, the receiver of FIG. 3 may be used to compare two Doppler-shifted versions of an incoming Galileo E1B or E1C PRN signal to a single code replica, by sampling the outputs of two of the input multipliers 21, each controlled to have a different frequency shift by the corresponding NCO 22. The output of the two multipliers is fed to the first two inputs of the multiplexer 24, leading to an interleaved sequence as shown in FIG. 5 being entered in the first shift register 3. In FIG. 5, each ‘1’ is a sample of the first PRN signal, and each ‘2’ is a sample of the second PRN signal. A single E1B or E1C code replica is generated 2 times as 4 blocks of 1023 chips, and the resulting 8 blocks are sampled and entered into multiplexer 6 which leads to the sequence of FIG. 6 being fed to the second shift register 7. The correlation, summing and maximum detection is done in the same way as described above.

According to an embodiment, the incoming signal 1 comprises complex values (0,0), (1,0) (0,1) or (1,1), for example the I and Q values of the incoming signal. In this case, the first shift register 3 comprises 30000 double registers (each register capable of containing two real values), and the correlations are calculated and summed for the I and Q values separately. The sum of the squares of the summed I and Q values is then preferably calculated and accumulated and the maximum of this sum of squared values, effectively representing the average energy, is detected.

As stated above, the multiplexing functions of the multiplexers 6 and 24 are controlled by the scheduler 20. In a preferred embodiment, the scheduler 20 controls how many of the input channels of the multiplexers are active. For example if only one channel is active, this is equivalent to turning off the multiplexing function altogether. In the embodiment illustrated in FIG. 5, only two channels of multiplexer 24 are active. This makes the architecture of FIG. 3 capable of performing all of the above-described calculations. FIG. 3 thus represents the architecture of an acquisition unit of a receiver according to the preferred embodiment of the invention. In this architecture it is also possible to process 8 different Doppler-shifted signals and 8 different code replica's simultaneously by actively using both multiplexers 6 and 24.

In the latter case, but also in other modes of operation, it may be required or preferable to select one or more subgroups of the 30000 sums stored in memory 12 and to perform the maximum detection only on these subgroups. The scheduler 20 is therefore preferably configured to be able to select specific subgroups from the memory 12.

Another embodiment comprises only the multiplexer 24 and not the multiplexer 6, with all other components being the same as in FIGS. 1 and 3. This embodiment is capable of acquiring 8 Doppler-shifted versions of an incoming PRN sequence and correlating these versions with a single sampled PRN replica, the PRN replica being sampled at 30 MHz, like the incoming Doppler-shifted versions. The correlation and summing operations and the determination of the maximum is done in the same way as in the above-described embodiments.

While the invention has been illustrated and described in detail in the drawings and foregoing description, such illustration and description are to be considered illustrative or exemplary and not restrictive. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A receiver for satellite navigation comprising:
an antenna for capturing a satellite signal,
a signal processor for deriving from the satellite signal a pseudorandom (PRN) sequence of code chips, at a chipping frequency f₀,
a converter for producing a digitized version of the received PRN sequence in the form of a sequence of samples at a sampling frequency fₛ,
a first shift register for receiving sampled values of the received PRN sequence,
a code generator for generating one or more replicas of respectively one or more pre-defined PRN codes, the replica or replicas having the form of a sequence of samples at the sampling frequency fₛ,
a second shift register for receiving sampled values of a PRN replica sequence,
a set of correlators for determining a correlation between the samples of the PRN replica sequence in the second shift register and the samples of the received PRN sequence in the first shift register,
circuitry for summing correlation values and circuitry for determining a maximum of the summed correlation values to determine a match between the received PRN sequence and a PRN replica,
a scheduler for controlling at least operation of the code generator, the shift registers, the correlators the summing circuitry and the circuitry for determining a maximum,
wherein
the receiver comprises at least one multiplexer, configured to transform multiple PRN sequences into an interleaved sequence and to enter said interleaved sequence into the first shift register or the second shift register,
the summing circuitry comprises multiple summing circuits for separately summing correlation values related to the multiple PRN sequences,
the circuitry for determining a maximum is configured to determine the maximum in one or more subgroups of sums determined by the multiple summing circuits.

2. The receiver according to claim 1, comprising a multiplexer configured to transform multiple different PRN replica sequences or multiple copies of a same PRN replica sequence into an interleaved sequence, and to enter said interleaved sequence into the second shift register.

3. The receiver according to claim 1, comprising:
circuitry for duplicating the received PRN sequence on a plurality of parallel lines,
a multiplier and a numerically controlled oscillator provided in relation to each of a plurality of said parallel lines, for applying a different frequency shift to a plurality of duplicates of the received PRN sequence,
a multiplexer configured to transform said plurality of frequency-shifted duplicates into an interleaved sequence and to enter said interleaved sequence into the first shift register.

4. The receiver according to claim 1, wherein the sampling frequency fₛ is higher than the chipping frequency f₀.

5. The receiver according to claim 1, wherein the scheduler is configured to control operation of the multiplexer or multiplexers, in such a way that the scheduler is capable of the number of input channels of the multiplexer that are activated.

6. The receiver according to, wherein the received PRN codes and the PRN replica codes comprise 1023 chips per millisecond.

7. The receiver according to claim 6 wherein the received PRN codes and the PRN replica codes comprise 4092 chips per 4 milliseconds, and wherein the 4092 chips are divided in 4 groups of 1023 chips, and wherein the four groups of a code replica are transformed into an interleaved sequence.

8. The receiver according to claim 1, wherein the at least one multiplexer is an 8-1 multiplexer.

9. Use of A process of using a receiver according to claim 1, comprising acquiring PRN signals comprising 1023 chips per millisecond.

10. Use of A process of using a receiver according to claim 1, comprising acquiring PRN signals comprising 4092 chips per 4 milliseconds, and wherein the PRN replicas of these signals are divided into four blocks of 1023 chips, and wherein the four blocks are transformed into an interleaved sequence.
